(19) United States
(12) Patent Application Publication
(10) Pub. No.: US 2008/0012194 A1
(43) Pub. Date: Jan. 17, 2008

(54) Device and method for suspending and supporting a workpiece to allow a user to apply a coating to the entire exterior surface thereof

(76) Inventor: Willie Leon Sapp, Lincoln, NE (US)

Correspondence Address: Turan Odabasi, 2201 Lynnridge Circle, Lincoln, NE, 68521, US

(21) Appl. No.: 11/825,772

(22) Filed: Jul. 9, 2007

Related U.S. Application Data
(60) Provisional application No. 60/819,782, filed on Jul. 10, 2006.

(51) Int. Cl. B23Q 3/00

(52) U.S. Cl. 269/296

(57) ABSTRACT

A novel device for suspending and supporting a workpiece to allow a user to apply a coating to the entire exterior surface of the workpiece at one time is disclosed herein. The device consists of a first plate, a second plate with a plurality slots formed therein, said second plate being removably attached to said first plate, a plurality of support members having proximal ends that are movably secured between said first plate and said second plate, and having distal ends that extend through said plurality of slots in said second plate; and attachment means disposed between said first plate and said second plate wherein said workpiece is suspended and supported upon said distal ends of said plurality of support members. The device can also be used to provide internal suspension and support of a workpiece through the use of a footing member removably attached to said first plate and second plate, a vertical support member attached to said footing member, a stabilizing flange attached to the distal end of said vertical support member, and attachment means disposed between said first plate, said second plate and said footing member, wherein an interior surface of said workpiece is in contact with said stabilizing flange thereby suspending and supporting said workpiece upon said vertical support member. In addition, a novel method for suspending and supporting a workpiece to allow a user to apply a coating to the entire exterior surface of said workpiece is also disclosed. This method comprises the steps of securing support means in a position corresponding to the shape and size of said workpiece, positioning said workpiece upon said support means, and applying a coating to the entire exterior surface of said workpiece.

### PRIORITY CLAIM

This application claims priority of U.S. Provisional Patent Application Ser. No. 60/819,782, filed Jul. 10, 2006, which is incorporated herein by reference.

### TECHNICAL FIELD

The present invention relates to the fields of pottery, ceramics and carpentry, specifically to a novel device and method for suspending and supporting a workpiece in such a position that a user may apply a coating to the entire exterior surface of the workpiece at one time.

### BACKGROUND OF THE INVENTION

In the arts of pottery, ceramics and carpentry, it is often necessary to apply a protective coating to a workpiece in order to preserve the workpiece and enhance its appearance. Such coatings often function not only to preserve and protect the workpiece, but to provide a good amount of the artistic detail and color of the finished work. However, without a device to support and suspend the workpiece in an appropriate manner, it is virtually impossible to apply a uniform coating to the entire exterior surface of a workpiece at one time.

For example, if an artist places a workpiece on a flat surface to apply a finish coating such as a glaze, the glaze will run down the surface of the workpiece and will tend to pool at the bottom of the workpiece at the point where the workpiece rests upon the flat surface. When the glaze cures, the resulting finish coating will be uneven and unattractive due to the pooling of the glaze at the bottom of the workpiece. Also, if the bottom of the workpiece needs to be glazed, the artist will need to apply a second coating of glaze to the bottom surface once the first coating has cured sufficiently, thus increasing the time necessary to finish the work. When applying a coating to workpieces that have multiple facets, such as intricate works of pottery or wood, several applications of coating must be applied as the workpiece must be oriented in different positions during the coating process in order to apply the coating to the entire surface of the workpiece—and this again increases the time necessary to finish the work.

Alternatively, the artist can prop or support the workpiece on various items (such as wood blocks, paper cups, scraps of metal and the like) in the workshop, thus allowing a greater surface area to be coated at one time. However, propping or supporting a workpiece in this manner can leave the workpiece in an unstable position where it can easily shift or fall off of these temporary supports.

Accordingly, novel devices and methods for suspending and supporting a workpiece in such a manner that a coating can be applied to the entire exterior surface of the workpiece at one time are a useful improvement to the fields of pottery, ceramics and carpentry.

### SUMMARY OF THE INVENTION

It is an object of the present invention to disclose a novel device for suspending and supporting a workpiece such that a coating may be applied to the entire exterior surface of the workpiece at one time.

It is another object of the present invention to disclose a novel device for suspending and supporting a workpiece such that a coating may be applied to the entire exterior surface of the workpiece at one time by means positioned on the exterior of the workpiece.

It is yet another object of the present invention to disclose a novel device for suspending and supporting a workpiece such that a coating may be applied to the entire exterior surface of the workpiece at one time by means positioned on the interior of the workpiece.

It is still another object of the present invention to disclose a novel method for suspending and supporting a workpiece such that a coating may be applied to the exterior surface of the workpiece at one time.

Accordingly, the present invention provides for a device for suspending and supporting a workpiece to allow a user to apply a coating to the entire exterior surface of said workpiece at one time, comprising a first plate; a second plate having a plurality of slots formed therethrough, said second plate being removably attached to said first plate; a plurality of support members having proximal ends that are movably secured between said first plate and said second plate, and having distal ends that extend through said plurality of slots in said second plate; and attachment means disposed between said first plate and said second plate; wherein said workpiece is suspended and supported upon said distal ends of said plurality of support members.

The present invention also provides for a device for suspending and securing a workpiece to allow a user to apply a coating to the entire exterior surface of said workpiece, comprising a base; a footing member removably attached to said base; a vertical support member attached to said footing member; a stabilizing flange attached to the distal end of said vertical support member, and attachment means disposed between said base and said footing member; wherein an interior surface of said workpiece is in contact with said stabilizing flange thereby suspending and supporting said workpiece upon said vertical support member.

Furthermore, the present invention also provides for a method for suspending and supporting a workpiece to allow a user to apply a coating to the entire exterior surface of said workpiece, comprising the steps of securing support means in a position corresponding to the shape and size of said workpiece; positioning said workpiece upon said support means; and applying a coating to the entire exterior surface of said workpiece.

Additional objects, advantages and novel features of the present invention will be set forth in part in the description which follows, and in part will become apparent to those skilled in the art upon examination of the following, or may be learned from practice of the invention.

### DESCRIPTION OF THE DRAWINGS

In the accompanying drawings which form a part of this specification and are to be read in conjunction therewith and in which like reference numerals are used to indicate like parts in the various views:

FIG. 1 is an exploded view of the present invention showing details of construction.

FIG. 2 is a perspective view of the present invention.

FIG. 3 is a perspective view of a support member.

FIG. 4 is a side elevation view of a support member.

FIG. 5 is a top plan view of a support member.

FIG. 6 is a top plan view of a second plate.

FIG. 7 is a top plan view of a first plate.

FIG. 8 is a perspective view of a vertical support member, a footing member and a stabilizing flange.

FIG. 9 is a top plan view of a footing member.

FIG. 10 is a perspective view of a footing member.

FIG. 11 is a perspective view of a vertical support member and a stabilizing flange.

FIG. 12 is a perspective view of the present invention with a footing member, a vertical support member and a stabilizing flange attached thereto.

FIG. 13 is a perspective view of a workpiece supported upon the present invention.

FIG. 14 is a perspective view of a the present invention with a footing member, a vertical support member and a stabilizing flange attached thereto, with a workpiece supported upon the stabilizing flange.

### DESCRIPTION OF THE INVENTION

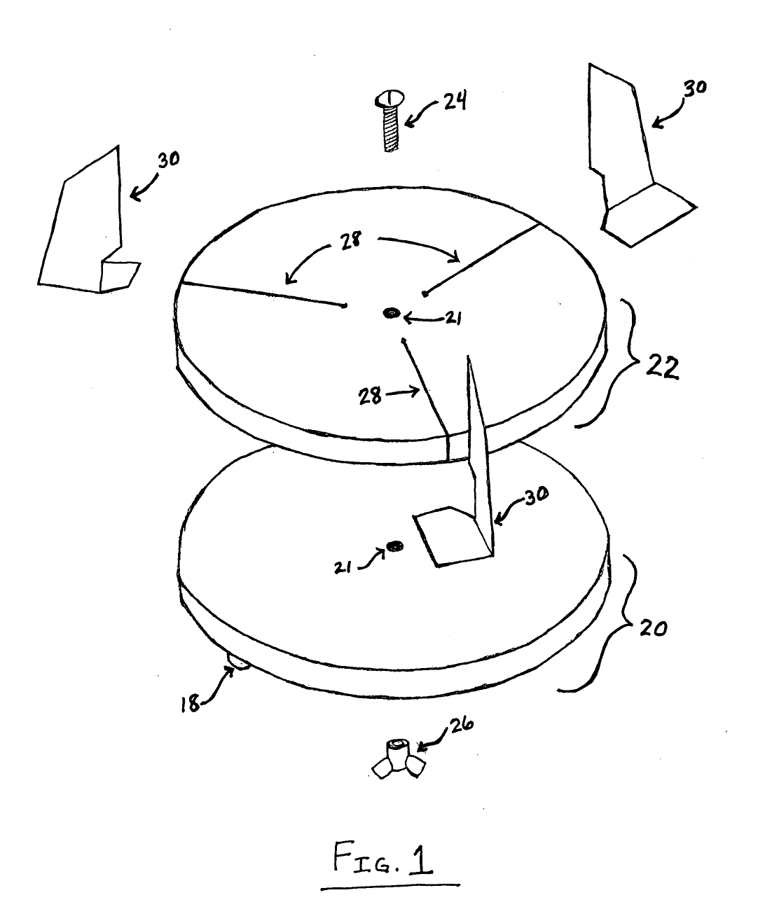

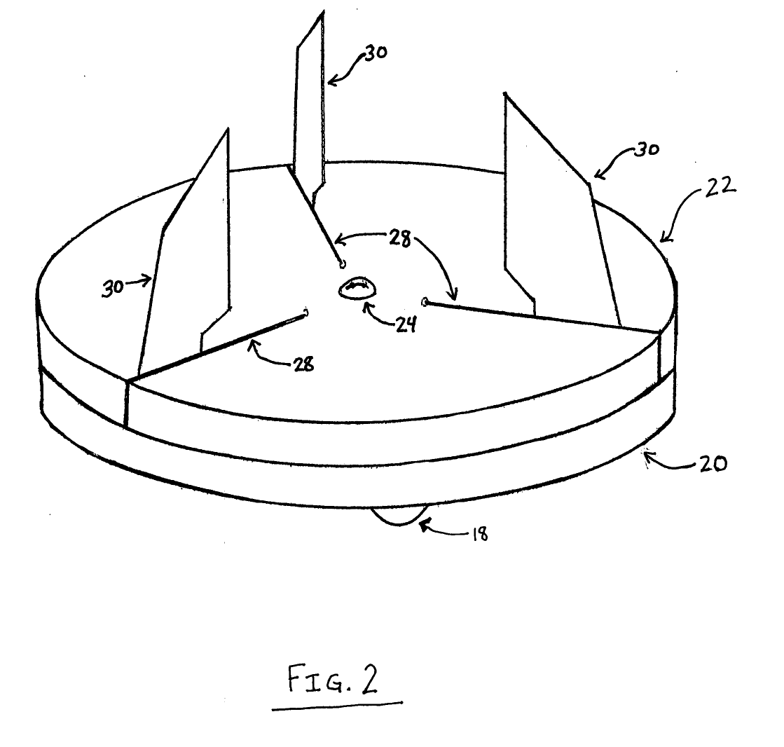

As shown in FIGS. 1 and 2, the device embodying the present invention comprises a first plate 20 removably attached to a second plate 22 by a screw 24 and nut 26. The first plate 20 and second plate 22 define a cavity 21 through which the screw 24 is positioned to receive the nut 26. A plurality of rubberized feet 18 are affixed to the bottom surface of the first plate 20 for the purpose of providing added stability to the device. The first plate 20 and second plate 22 are ideally formed from wood, plastic, hardened rubber, or a similar resilient, non-corrosive material. The second plate 22 contains a plurality of slots 28. Each of the slots 28 is formed such that a support member 30 can be positioned in and extend through the slots 28 while being held in position between the first plate 20 and second plate 22.

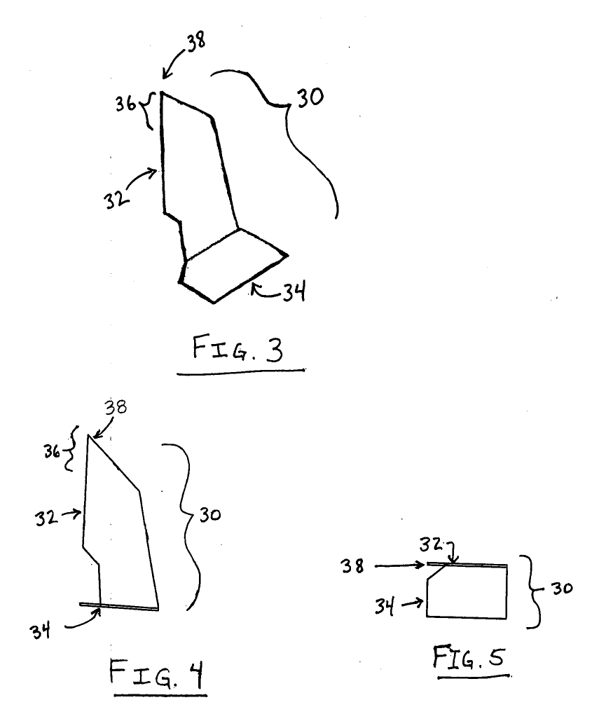

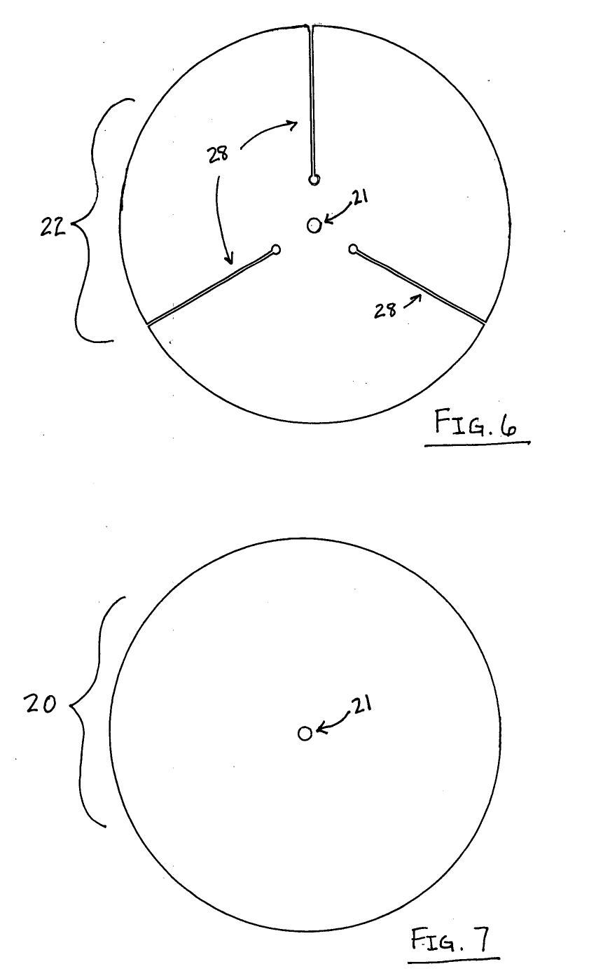

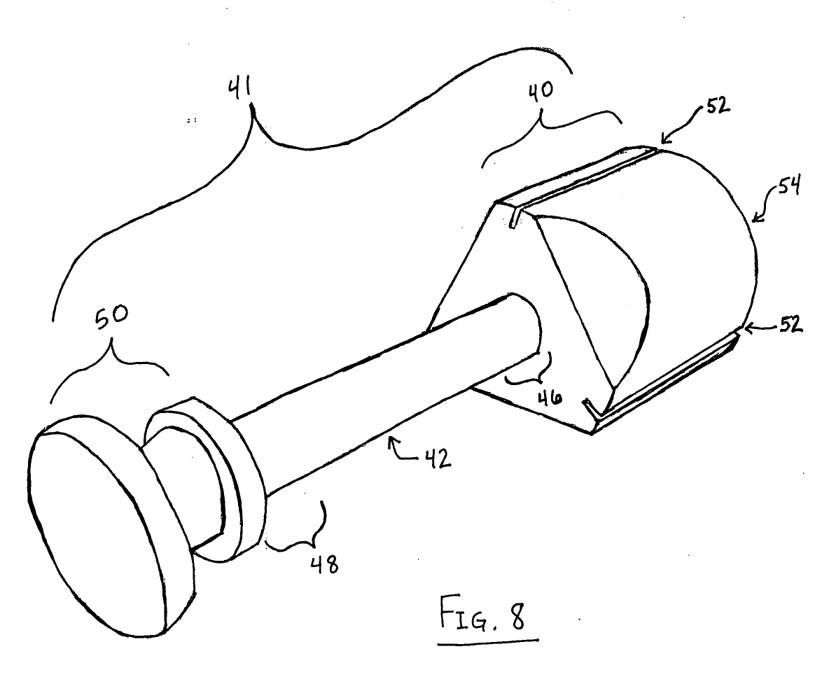

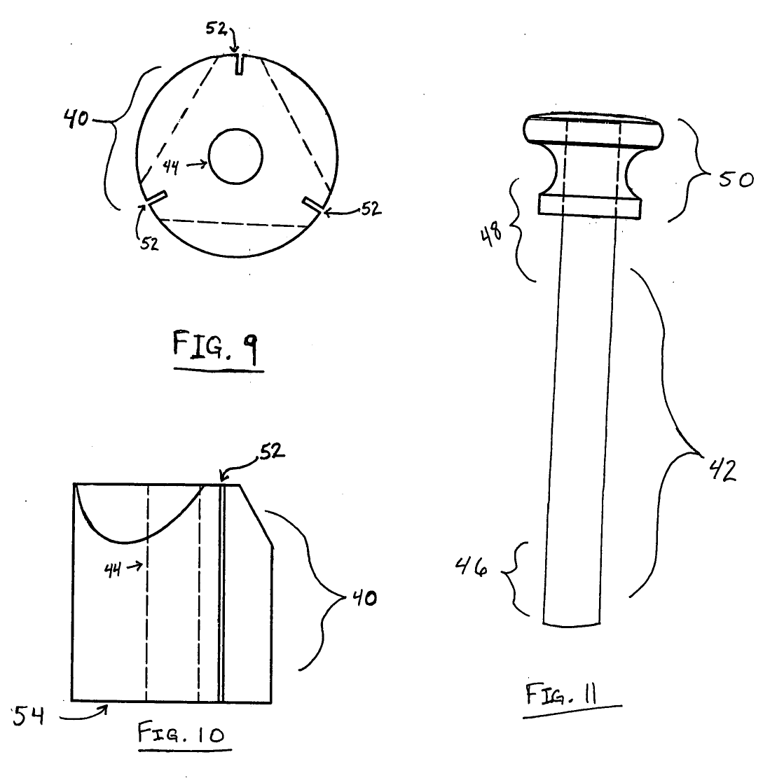

An embodiment of a support member 30 is further illustrated in FIGS. 3, 4 and 5. The support member 30 is ideally formed from a single piece of stainless steel, copper or similar resilient, non-corrosive material. The support member 30 is formed in an L-shape configuration having a first segment 32 and a second segment 34 positioned at a ninety degree angle from each other. When placed in position between the first plate 20 and second plate 22, the first segment 32 extends upward completely through the slot 28 in the second plate 22. The distal end 36 of the first segment 32 is tapered to a point 38. The second segment 34 is held in a frictional fit between the first plate 20 and second plate 22 when the screw 24 is tightened to the nut 26. When the screw 24 is loosened from the nut 26, the support members 30 may be freely moved the length of the slots 28.

Optimally, the slots 28 extend from very near the center of the second plate 22 through the outside of the second plate 22, so that the support members 30 can slide freely through the length of the slots 28 thereby allowing a user to position the support members 30 in numerous positions depending on the size and shape of the workpiece 60. This design also allows for the support members 30 to be easily removed from the device for storage purposes, for replacement purposes, or if it becomes necessary to use support members 30 of larger or smaller size depending on the size and/or shape of the workpiece 60. Also, the entire device can easily be disassembled for storage and reassembled for use.

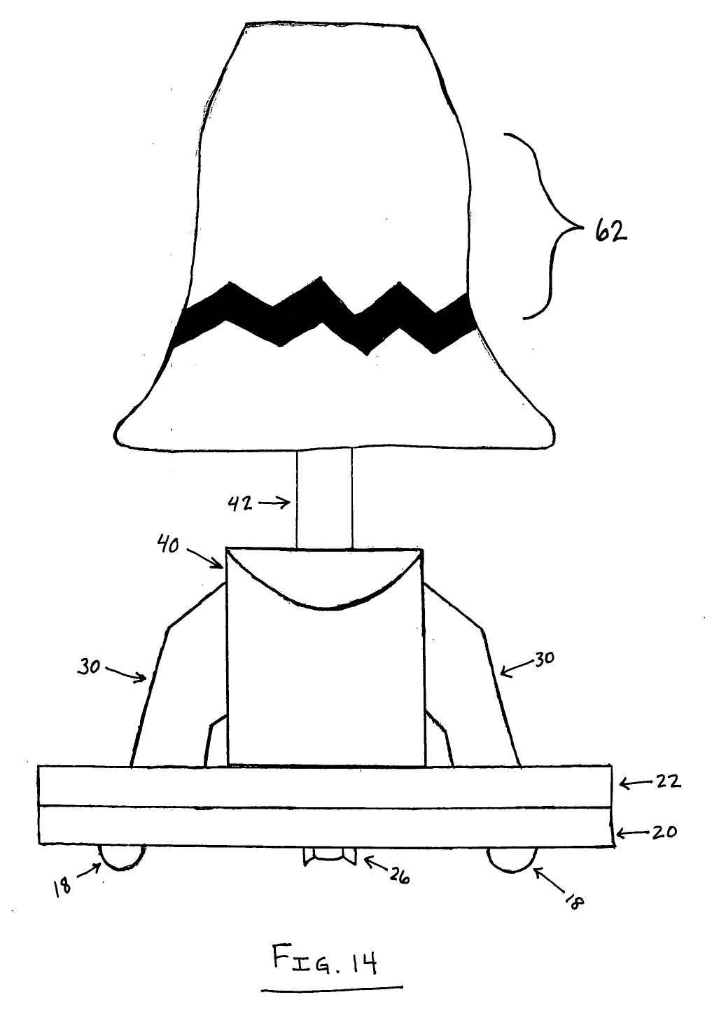

As shown in FIG. 13 when a plurality of support members 30 are employed in such a fashion, the first segment 32 of each support member is positioned as necessary to support a workpiece 60 on the points 38 of the first segment 32 of the support members 30. The support members 30 are held tightly in place by the second segment 34 and a frictional fit between the second segment 34, the first plate 20 and second plate 22. Thus, the plurality of support members 30 can firmly support the workpiece 60 in such a manner that a user can apply a coating to the entire exterior surface of the workpiece 60 at one time. Only the minuscule portions of the workpiece 60 that contact the points 38 during the application of the coating will not be coated. The user can touch up these miniscule portions if necessary once the coating cures.

The circular configuration of the device illustrated in FIGS. 1, 2, 6 and 7 may be desirable for many ceramic and pottery applications. However, other configurations, shapes and sizes of the first plate 20 and second plate 22 may also be desirable and useful for different purposes and are certainly contemplated herein. By way of example, for workpieces of different shapes, a square, rectangular or octagonal shaped pair of plates may be desirable. Also, more than three slots 28 in the second plate 22 allowing for more than three support members 30 may also be desirable for large or intricately designed workpieces 60 requiring more support.

Use of the device is accomplished by a user loosening the nut 26 from the screw 24, thereby releasing the tension between the first plate 20 from the second plate 22. Once the tension has been released, the user can insert and freely move the support members 30 into such position as is needed to adequately support the workpiece 60 to be coated. Once in position, the user tightens the nut 26 onto the screw 24, creating a frictional fit between the first plate 20, the second segment 34 of the support members 30, and the second plate 22. The user then places the workpiece 60 atop the points 38 of the support members 30 and can begin applying the coating to the exterior surface of the workpiece 60. FIG. 13 illustrates a workpiece 60 supported upon the present invention. The device and workpiece 60 may be placed together in a fume hood or other apparatus to aid in curing the coating applied to the workpiece 60.

Certain shapes of pottery, ceramic and wood articles, such as vases, bottles, slender pots and the like, may be more easily supported through the use of an internal support device. The present invention also provides for this type of support. As shown in FIGS. 8, 9, 10 and 11, the present invention provides for such support of a workpiece with an expanded interior cavity 62 such as these through the use of a vertical support member 42. With reference to FIG. 8, an internal support device 41 comprised of a footing member 40, a vertical support member 42, and a stabilizing flange 50, is attached to the device via a plurality of grooves 52 formed within the exterior surface of the footing member 40. These grooves 52 correspond to the positioning of the support members 30 in the second plate 22. Thus, as shown in FIG. 12, the support members 30 fit into the grooves 52 and stabilize the distal end 54 of the footing member 40 on top of the second plate 22 via the support members 30 when the nut 26 is tightened to the screw 24 thereby fixing the support members 30 in place within the grooves 52. Alternatively, the footing member 40 of the internal support device 41 may be affixed to the first plate 20 and second plate 22 by use of a screw attached to the distal end 54 of the footing member 40, extending through the first plate 20 and second plate 22, and tightening a nut to this screw.

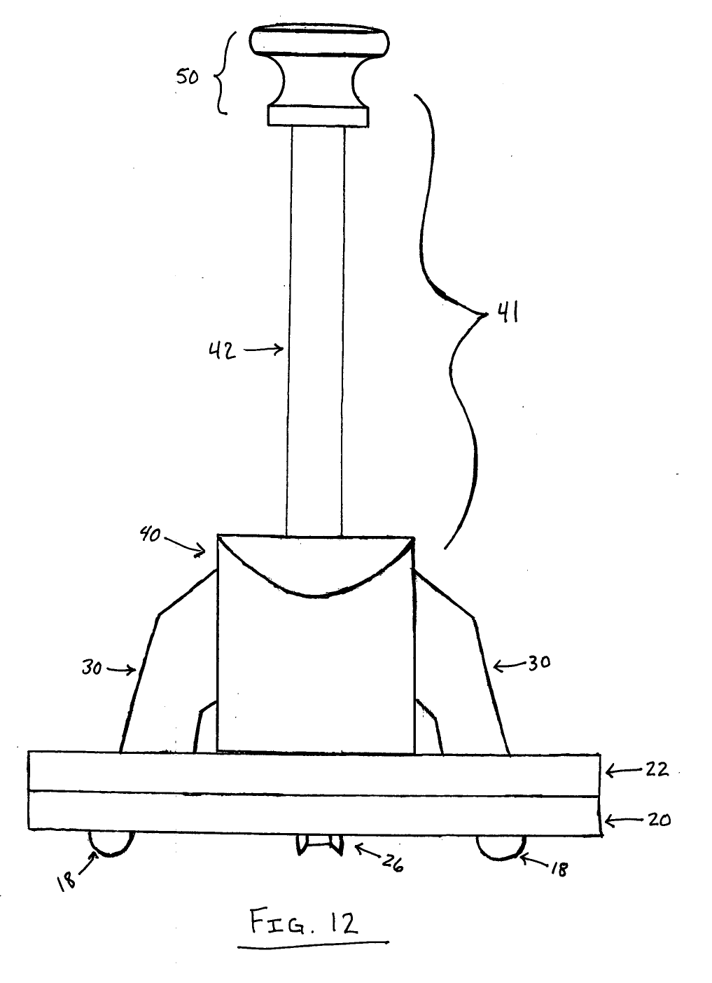

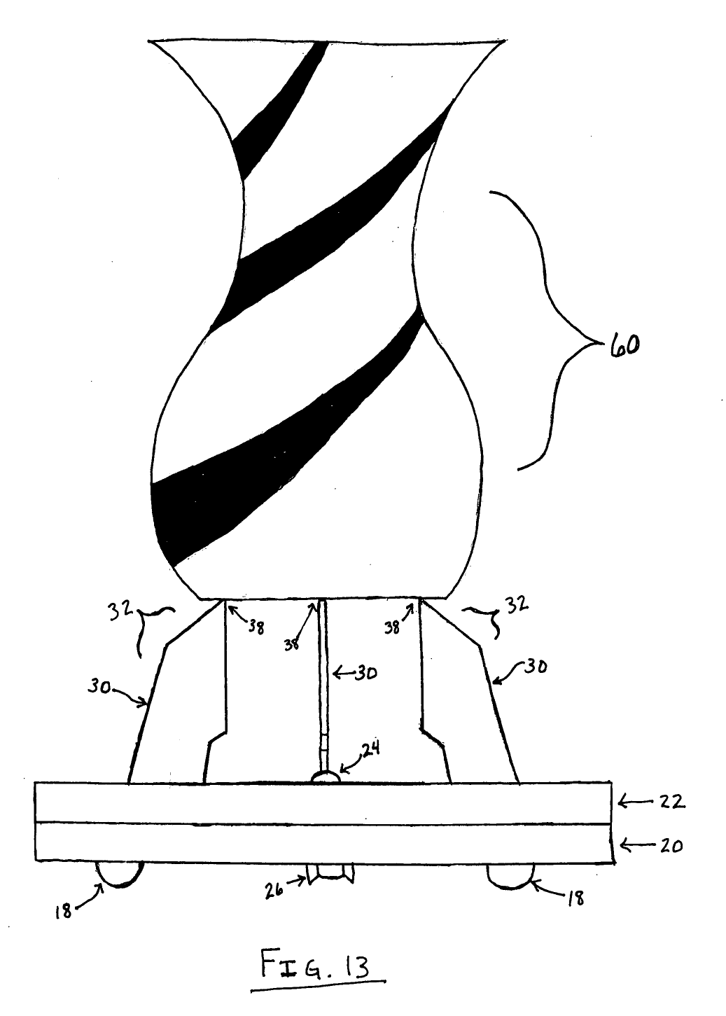

As shown in FIG. 10, the footing member defines a cavity 44 into which the proximal end 46 of the vertical support member 42 is received and secured in a vertical position. As shown in FIG. 11, the distal end 48 of the vertical support member 42 is attached to a stabilizing flange 50. Accordingly, as shown in FIG. 14, in this configuration a workpiece with an expanded interior cavity 62 may be inverted and placed over the vertical support member 42 such that the stabilizing flange 50 contacts and supports the bottom of the interior surface of the workpiece with an expanded interior cavity 62. With the workpiece with an expanded interior cavity 62 is suspended and supported in this position, a user may apply a coating to the entire exterior surface of this workpiece at one time.

What is claimed is:

1. A device for suspending and supporting a workpiece to allow a user to apply a coating to the entire exterior surface of said workpiece at one time, comprising:
(a) a first plate;
(b) a second plate having a plurality of slots formed therethrough, said second plate being removably attached to said first plate;
(c) a plurality of support members having proximal ends that are movably secured between said first plate and said second plate, and having distal ends that extend through said plurality of slots in said second plate; and
(d) attachment means disposed between said first plate and said second plate;
wherein said workpiece is suspended and supported upon said distal ends of said plurality of support members.

2. The device of claim 1 wherein at least three slots are formed in said second plate.

3. The device of claim 1 wherein at least three support members are movably secured between said first plate and said second plate.

4. The device of claim 1 wherein said distal ends of said support members are tapered to a point.

5. The device of claim 1 wherein said attachment means comprises a screw and nut.

6. A device for suspending and securing a workpiece to allow a user to apply a coating to the entire exterior surface of said workpiece, comprising:
(a) a base;
(b) a footing member removably attached to said base;
(c) a vertical support member attached to said footing member;
(d) a stabilizing flange attached to the distal end of said vertical support member, and;
(e) attachment means disposed between said base and said footing member;
wherein an interior surface of said workpiece is in contact with said stabilizing flange thereby suspending and supporting said workpiece upon said vertical support member.

7. The device of claim 6 wherein said attachment means comprises a plurality of support members extending from said base, said support members being capable of securing the outer surface of said footing member to said base.

8. The device of claim 6 wherein said attachment means comprises a screw attached to the lower end of said footing member and extending through said base, and a nut attached to the opposite end of said screw.

9. A method for suspending and supporting a workpiece to allow a user to apply a coating to the entire exterior surface of said workpiece, comprising the steps of:
(a) securing support means in a position corresponding to the shape and size of said workpiece;
(b) positioning said workpiece upon said support means; and
(c) applying a coating to the entire exterior surface of said workpiece.

10. The method of claim 9 wherein said support means consists of a plurality of support members movably secured to a base.

11. The method of claim 9 wherein said support means consists of:
(a) a first plate;
(b) a second plate with a plurality slots formed therein, said second plate being removably attached to said first plate;
(c) a plurality of support members having proximal ends that are movably secured between said first plate and said second plate, and having distal ends that extend through said plurality of slots in said second plate; and
(d) attachment means disposed between said first plate and said second plate;
wherein said workpiece is suspended and supported upon said distal ends of said plurality of support members.

12. The method of claim 9 wherein said support means consists of:
(a) a base;
(b) a footing member removably attached to said base;
(c) a vertical support member attached to said footing member;
(d) a stabilizing flange attached to the distal end of said vertical support member, and;
(e) attachment means disposed between said base and said footing member;
wherein an interior surface of said workpiece is in contact with said stabilizing flange thereby suspending and supporting said workpiece upon said vertical support member.
